(19) United States
(12) Patent Application Publication
(10) Pub. No.: US 2005/0276073 A1
(43) Pub. Date: Dec. 15, 2005

(54) Diffusive reflector films for enhanced liquid crystal display efficiency

(75) Inventors: Xiang-Dong Mi, Rochester, NY (US); Ronald J. Sudol, Rochester, NY (US); Thomas M. Laney, Spencerport, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/857,515

(22) Filed: May 28, 2004

(51) Int. Cl. F21V 7/04

(52) U.S. Cl. 362/609; 362/620

(57) ABSTRACT

A display apparatus includes a light guide having at least two surfaces over which a diffusively reflective layer is disposed. Moreover, a method of transmitting light to a display includes providing a light guide, and diffusively reflecting light from at least two surfaces of the light guide. The display apparatus may include a transmissive light valve such as a transmissive liquid crystal display.

### FIELD OF THE INVENTION

A diffusive reflector film is described for use in enhancing light efficiency.

### BACKGROUND OF THE INVENTION

Light-valves are implemented in a wide variety of display technologies. For example, microdisplay panels are gaining in popularity in many applications such as televisions, computer monitors, point of sale displays, personal digital assistants and electronic cinema to mention a few applications.

Many light valves are based on liquid crystal (LC) technologies. Some of the LC technologies are prefaced on transmittance of the light through the LC device (panel), while others are prefaced on the light traversing the panel twice, after being reflected at a far surface of the panel.

An external field or voltage is used to selectively rotate the axes of the liquid crystal molecules. As is well known, by application of a voltage across the LC panel, the direction of the LC molecules can be controlled and the state of polarization of the reflected light is selectively changed. As such, by selective switching of the transistors in the array, the LC medium can be used to modulate the light with image information. Often, this modulation provides dark-state light at certain picture elements (pixels) and bright-state light at others, where the polarization state governs the state of the light. Thereby, an image is created on a screen by the selective polarization transformation by the LC panel and optics to form the image or ‘picture.’

In many LCD systems, the light from a source is selectively polarized in a particular orientation prior to being incident on the LC layer by an absorptive polarizer. The LC layer may have a voltage selectively applied to orient the molecules of the material in a certain manner. The polarization of the light that is incident on the LC layer is then selectively altered upon traversing through the LC layer. Light in one linear polarization state is transmitted by a polarizer (often referred to as an analyzer) as the bright state light; while light of an orthogonal polarization state is reflected or absorbed by the analyzer as the dark-state light.

While LCD devices are becoming ubiquitous in display and microdisplay applications, there are certain drawbacks associated with known devices. For example, in known devices some of the light from the light source may be irrecoverably lost and the overall brightness of the image is adversely impacted. Moreover, in many compact display structures, a light guide is used to direct light from the light source to the LC panel and the display surface. However, in known structures the light guide can act as a waveguide, which prevents an unacceptable portion of the light from the source from being transmitted to the LC panel.

What is needed therefore is an apparatus that overcomes at least the drawbacks of known devices described above.

### SUMMARY OF THE INVENTION

In accordance with an example embodiment, a display apparatus includes a light guide having at least two surfaces over which a substantially diffusively reflective layer is disposed. The substantially diffusive reflective layer has a reflectivity of at least 94% and a diffusitivity of at least 97%.

In accordance with another example embodiment, a method of transmitting light to a display includes providing a light guide, and diffusively reflecting light from at least two surfaces of the light guide.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a cross-sectional view of a liquid crystal display device in accordance with an example embodiment.

FIG. 2 is a perspective three-dimensional view of a light guide in accordance with an example embodiment.

FIG. 3 is a conceptual representation showing diffuse and specular reflection as they may apply to example embodiments.

FIG. 4 is a cross-sectional view of a light guide in accordance with an example embodiment.

FIG. 5 is a tabular representation showing the normalized illuminance from an output surface of a light guide having a variety of reflective surfaces according to an example embodiment.

### DETAILED DESCRIPTION OF THE INVENTION

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known apparati and methods may be omitted so as to not obscure the description of the example embodiments. Such methods and apparati and methods are clearly within the contemplation of the inventors in carrying out the example embodiments. Wherever possible, like numerals refer to like features throughout.

Briefly, and as described in detail in conjuctions with example embodiments, a diffusive reflective film is disposed over a light guide to improve the illumination level at a light valve, which is illustratively a LC panel. Illustratively, the light guide receives light from a light source at one surface, and transmits light to the LC panel via another surface. Diffusively reflective dots are disposed along a surface that is opposite to the surface that transmits the light to the LC panel. A diffusively reflective layer, which is described more fully herein, is then disposed over at least one of the remaining surfaces of the light guide. In accordance with another example embodiment, a specularly reflective layer may be disposed over at least one reflective surface of the light guide and/or about the light source.

Beneficially, by choosing the appropriate type of reflector (diffusive or specular) at each surface, the total flux and uniformity of the light at the LC panel is improved significantly compared to known devices. Moreover, as will become clearer as the present description continues, light is recycled after being reflected from various elements useful in forming an image in a display device or system. These and other example embodiments are described presently.

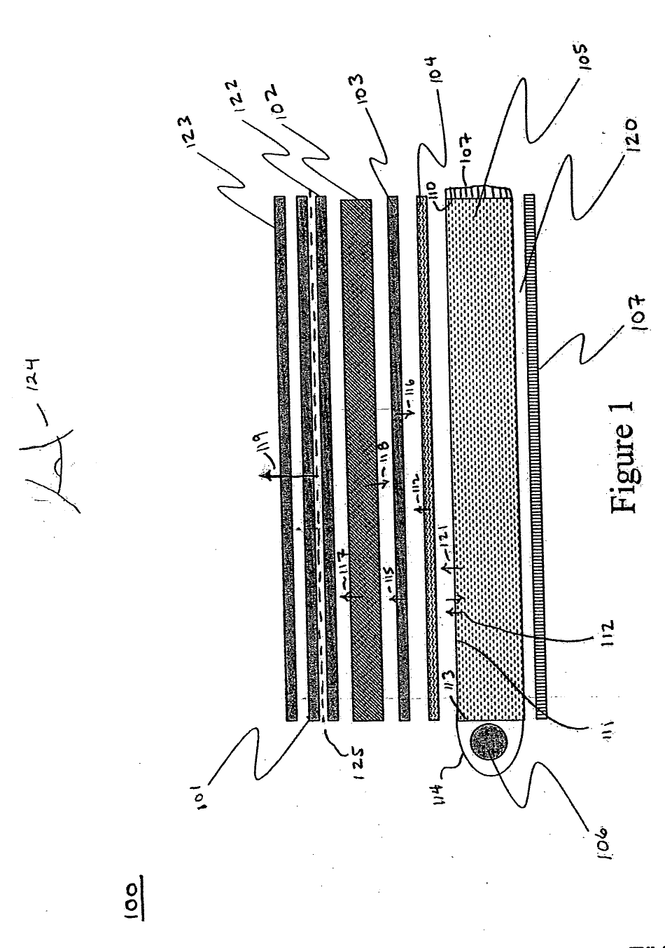

FIG. 1 is a cross-sectional view of a light-valve imaging device 100 of an example embodiment. The imaging device 100 includes a transmissive light-valve 101, which is illustratively an LC panel. A backlight assembly includes a polarization selective reflector 102, a brightness enhancement layer 103 and a diffuser layer 104. As is readily appreciated by one of ordinary skill in the art, the backlight assembly provides a uniform light distribution to the light valve 101, with an angular distribution of light that is designed to meet the angular field of view required by an end-user. For example, a laptop computer with a brightness enhancement layer has a viewing angle that is typically on the order of approximately ±20 degrees off-center axis.

Beneath the diffuser layer 104 is a light guide 105, which is coupled to at least one light source 106. The light guide 105 has a diffusive reflector layer 107 disposed over at least a one surface. Illustratively, layer 107 is disposed over a bottom surface 108 and a side surface 110 of the light guide 105. As will become clearer as the present description continues, the diffusive reflector layer 107 is beneficially disposed on all surfaces of the light guide 105, except the transmissive surface 111 opposite the bottom surface, and the surface 113, which is coupled to the light source 106. In an example embodiment layer 107 has an index of refraction that is substantially the same as or greater than an index of refraction of the light guide 105. In another example embodiment layer 107 has an index of refraction that is less than an index of refraction of the light guide 105.

The light source 106 includes a reflector 114, which serves to improve the intensity of the light coupled from the light source to the light guide 105. In accordance with an example embodiment, the reflector 114 is a specular reflector of the light. Illustratively, the lamp reflector 114 can be of a metallic layer such as aluminum or a non-metallic specular reflector film such as Vikuiti™ Enhanced Specular Reflector (ESR) film with over 98.5% reflectivity. As they relate to the present example embodiments, specular and diffuse reflection are described in detail below.

In an example embodiment, the light source 106 is one of: cold cathode fluorescent lamp (CCFL); a light emitting diode (LED) or an array thereof; an organic LED or array thereof; or an ultra-high pressure (UHP) gas lamp or other source of randomly polarized white light. The light source 106 is coupled to the light guide and light 112 is optimally transmitted via surface 111. As described more fully herein, light 112 is randomly polarized and may be transmitted through surface 111 toward the light valve 101. Alternatively, light 112 may be transmitted back through surface 111 after reflection from elements of the backlight assembly, the brightness enhancement layers 103, or the polarization selective reflector 102. This light 112 may then be recycled and re-transmitted. This recycling is useful in improving the light efficiency. Moreover, the diffusive reflection from the light guide provides randomly polarized recycled light.

Beneficially, the material from which the light guide 105 is formed may be a polymeric material such as polycarbonate, polystyrene, polymethyl methacrylate (PMMA), or other methacrylates, acrylates, acetates for the intended purposes of the example embodiments. As will become clearer as the present description continues, it is beneficial to have an air gap 120 between the layer 107 and the lower surface 108 of the light guide 105. This air gap 120 in combination with reflective dots or microstructures (not shown) on the lower surface 108 fosters a more uniform output from the light guide to the LC panel 101, and thus to the image plane (not shown). It is noted that the air gap 120 assists in the frustration of waveguiding by the light guide 105. Finally, it is noted that no affirmative measure must be made to effect the air gap 120. To wit, the air gap 120 will exist between the layer 107 and the light guide 105 unless remedial steps are taken to prevent the gap 120 (e.g., the use of an index matching layer between the layer 107 and the light guide).

While it is useful to provide an air gap between the lower surface 108 and the layer 107 disposed thereover, an air gap is not necessary on the side surfaces (e.g., 110). To this end, the layer 107 may be disposed over the side surfaces as desired using an optical adhesive layer that has an index matching property. This adhesive (not shown) will foster the diffuse scattering of the light, and prevent the (specular) reflection of light and thus waveguiding by the light guide.

Because it is beneficial to provide diffuse light to the light valve 101, light 112 traverses the optional diffuser layer 104. It is emphasized that the diffuser layer 104 is optional since the diffusive reflection provided by the layer 107 of the example embodiment is sufficient to provide the requisite diffusivity of the light. In accordance with an illustrative embodiment, a layer 107 is a diffusively reflecting layer described in co-pending application serial numbers (Kodak Attorney Docket Numbers 87340US1 and 86349US1), entitled “Highly Reflective Optical Element,” and “Highly Reflective Optical Element”, respectively, both of which are assigned to the present assignee. The disclosure of this application is specifically incorporated herein by reference.

As described in further detail herein, according to illustrative embodiment, it is possible to provide a specularly reflective layer at least one selected surfacess of the light guide 105. In these embodiments, specularly reflecting films including metallic or multilayer films, known to one of ordinary skill in the art, may be used. For example, Vikuiti™ Enhanced Specular Reflector (ESR) film, manufactured by Minnesota Mining and Manufacturing, Incorporated, may be used as such a specular reflector.

After traversing the diffusive layer 104, the light 112 traverses the brightness enhancement layer 103. The brightness enhancement layer 103 beneficially provides light in a prescribed angular distribution 115 to the selectively reflective polarizer 102. To this end, the brightness enhancement layer 103 redirects light (through recycling) that would be otherwise lost, and unobserved at the image screen because it is too far off axis to contribute to the image. As such, light 116 that is oriented in an undesirable trajectory to be on-axis at the viewing screen is reflected. As will be clearer as the present description continues, at least a portion of light 116 is recycled and transmitted to the light valve 101, providing improved on-axis brightness.

In accordance with example embodiments, the brightness enhancement layer 103 is a commercially available element. For example, the brightness enhancement layer may be a Vikuiti™ Brightness Enhancement film, which is offered by Minnesota Mining and Manufacturing, Incoporated, as well as other known films that enhance brightness in display applications.

Light 115 is transmitted to the reflective polarizer 102, which transmits light 117 of a first polarization state and reflects light 118 of a second polarization state, which is orthogonally polarized relative to the first polarization state. The reflective polarizer may be one of a variety of reflective polarizers well known to one of ordinary skill in the optical arts.

The transmitted light 117 of the first polarization state is essentially linearly polarized along the transmission axis of a polarizer 122 disposed beneath the light valve 101. The reflected light 118 of the second polarization state, which is essentially linearly polarized along the absorption axis of the polarizer 122, thus is reflected and avoids being absorbed by the polarizer 122.

As referenced previously, the light valve 101 is illustratively an LC panel. LC materials are widely used for electronic displays. In an illustrative embodiment, an LC panel 101 is situated between a polarizer (e.g., polarizer 122) and an analyzer 123, and the LC material has a director exhibiting an azimuthal twist through the layer with respect to the normal axis. The analyzer 123 is oriented such that its absorbing axis is perpendicular to that of the polarizer 122. Incident light polarized by the polarizer 122 passes through a liquid crystal cell and may be transformed to a polarization state that is substantially orthogonal to its polarization state at incidence to the LC cell 101. As is known, this polarization transformation is dependent on the molecular orientation in the liquid crystal, which can be altered by the application of a voltage across the cell. By employing this principle, the transmission of light from an external source, including ambient light, can be controlled to form an image.

Accordingly, the transmitted light 117 is incident on the polarizer 122 and the light valve 101, which modulates the light incident thereon and transmits light 119 that forms the image (not shown). As is known in the image display arts, dark pixels are formed by selective absorption by the analyzer 123 after the selective transformation of the polarization state of the light 115 to be substantially parallel to the absorption axis of the absorber.

The reflected light 116 and 118 are at least partially transmitted back through surface 111 of the light guide 105. The reflected light 116 and 118 are then incident on at least one of the surfaces of the light guide 105. As described previously, the layer 107 is disposed over at least two of the surfaces (e.g., surfaces 108, 110) of the light guide 105. Moreover, dots (not shown in FIG. 1) are disposed over the bottom surface 108, and optionally over selected sides of the light guide 105.

According to the example embodiments, the reflected light 116, 118 is diffusively reflected by the layer 107 and the dots. Among other affects, this reflection causes light 121 to be randomly polarized. As referenced previously, this randomly polarized light may then be transmitted through the surface 111. Thereby, the light reflected by the brightness enhancement layer 103 by the reflective polarizer 102, and by the light valve 101, all of which would have been lost, is transmitted back through the surface 111. As can be appreciated, the light 121 is randomly polarized, and the polarization selection continues in a recycling process. Ultimately, this fosters an improved light uniformity and on-axis illuminance (e.g., at viewing location 124), and thus improved brightness at the imaging surface.

As can be readily appreciated from the discussion of example embodiments thus far, the light recycling and beneficial light efficiency improvement of the embodiment are accomplished mainly via the reflective polarizer 102 and brightness enhancement layer 103 used in conjunction with the layers 107. Certain details of the recycling process of example embodiments, which significantly improves light efficiency and the uniformity of the illumination at the light valve 101 and imaging surface are described more fully presently.

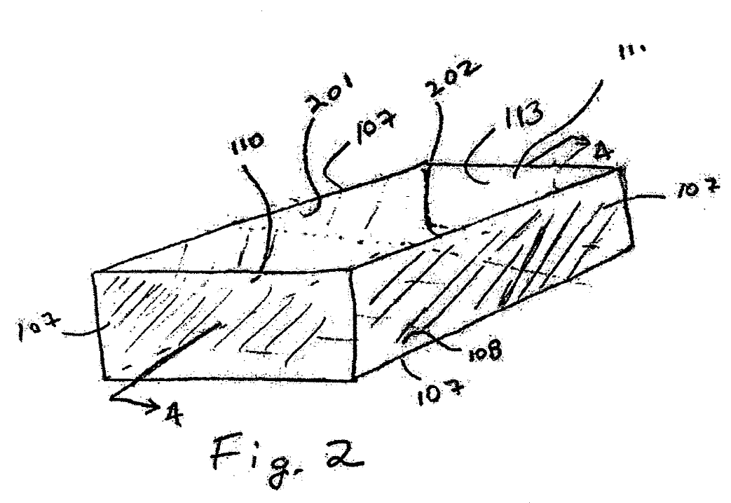

FIG. 2 is a perspective view of the light guide 105 according to an example embodiment. It is noted that the rectangular parallelpiped shown is merely illustrative of the geometric shape of the light guide 105. To this end, the light guide 105 also may be a prism, a regular polyhedron or a polyhedron. Moreover, it is noted that more than one light guide may be used. Of course, the light guide 105 may be of other shapes than those explicitly referenced in order to improve the efficiency of light to the light valve and thus the image surface.

In the present illustrative embodiment the layer 107 is disposed over surfaces 108, 110, 201 and 202 of the light guide 105. It is noted that the layer 107 is not disposed over the surface 111 or surface 113, which are the top or transmissive surface, and the surface to which the light source couples, respectively. Accordingly, in the present illustrative embodiment, four of six surfaces have the layer 107 disposed thereover. As will become clearer as the present description continues, there are significant performance benefits in having the diffusive reflective layer 107 disposed over these four surfaces of the light guide 105 and a specularly reflective layer about the light source 105 (e.g., layer 114). However, it is not essential to have the diffusive reflective layer 107 disposed over all four surfaces 108, 110, 201, 202. To this end, the layer is necessarily disposed over the surface 108 and at least one other surface.

Finally, it was previously noted that more than one light source may be used according to illustrative embodiments. For example, in an example embodiment, the layer 107 may be omitted from surface 110, and a second CCFL or other suitable device with a reflector similar to 114 may be used. Of course, this is merely illustrative, and the second light source or additional light sources may be disposed over other surfaces of the waveguide in lieu of the layer 107 may be used.

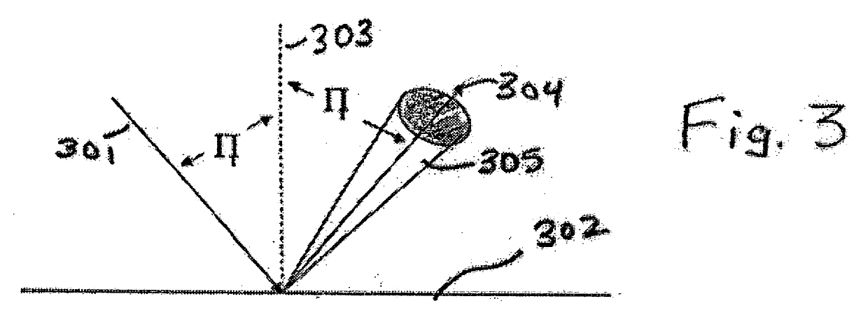

Before delving into a detailed discussion of the optical properties of the light guide according to example embodiments, a description of the specular and diffuse reflection is beneficial. FIG. 3 illustrates the properties of a reflector. To wit, light 301 is incident on the surface 302 of a reflector at an angle of incidence (Π) relative to a normal to the surface 303. A special case of specular reflection occurs when the angle of reflection (Π) equals the angle of incidence (Π), as shown at 304. Generally, the term specular reflection applies to incident light 301 that is reflected within a cone 305 that is approximately ±10 degrees from the direction 304.

However, the reflector is a diffusive reflector when the incident light 301 is reflected from the surface of the reflector 302 at an angle outside the cone 305. It is noted that according to example embodiments, diffusively reflective surfaces beneficially obey Lambert's cosine law, which states that the reflected luminous intensity in any direction from an element of a perfectly diffusing surface varies as the cosine of the angle between that direction and the normal vector (normal 303) of the surface. As a consequence, the luminance of that surface is the same regardless of the viewing angle. Often, this law described matte surfaces. In practice many surfaces including white dots have some percentage in specular reflection, and some percentage in diffuse reflection. An ideal Lambertian reflector has 100% diffuse reflection, and 0% specular reflection. It is understood that a reflector has a high percentage of diffuse reflection is a good candidate as a Lambertian (or diffusive) reflector in example embodiments.

In accordance with illustrative embodiments, the layers 107 disposed on the surfaces of the light guide 105 and reflector 114 may be diffusively reflective or specularly reflective. The layers 107 of the example embodiments are beneficially diffusively reflective materials. To this end, the layers 107 are highly diffusively reflective, providing on the order of approximately 98% diffuse reflection of light, and less than approximately 2% in specular reflection. As a comparison, an ESR reflector has approximately 1% to approximately 3% in diffuse reflection, and approximately 97% to approximately 99% in specular reflection.

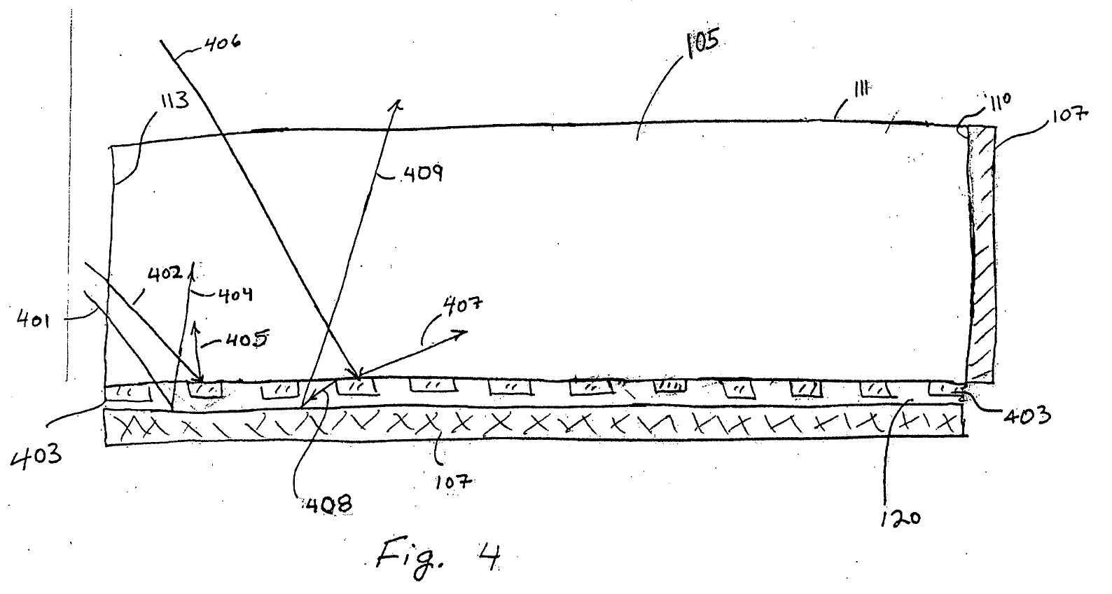

FIG. 4 is a cross sectional view of the light guide 105 of FIG. 2 taken along line 4-4. The light guide 105 receives light from at least one light source (not shown). For example, the light guide 105 illustratively receives randomly polarized light 401, 402 from a light source through surface 113. The light 401 is illustratively incident on the lower surface 108 and is reflected as light 404 by the layer 107 disposed thereover. Moreover, light 402 is incident on dots 403, which diffusively reflect light 405. As can be appreciated, light 404 and 405 are transmitted through surface 111 to the remainder of the backlight assembly components, described in connection with the example embodiments of FIG. 1. Ultimately, the combination of the dots 403 and the layers 107 improve the uniformity and flux of the light transmitted from the light source to the display device.

In an example embodiment, the dots 403 are illustratively elliptical in shape and are disposed within the light guide 105. These dots are disposed on a lower surface 108 in the example embodiment, but may be disposed on other surfaces to assist in the diffusive reflection of the light from the light source or light reflected by the components of the back light assembly or the light valve. The dots 403 can take other forms such as circles, rectangles, or squares. The dots 403 are generally formed from a colorant that is substantially not light absorptive and has a reflectance of light greater than approximately 90%. In an example embodiment, the dots 403 are screen printed with increasing density with distance from the light source to achieve uniform illuminance. Beneficially, the dots 403 substantially diffusively reflect incident light to extract light from the light guide 105 in order to increase the efficiency and uniformity of the light transmitted to the light valve and thus the display surface.

It is noted that in example embodiments, the dots 403 may be microstructures such as bumps or grooves disposed over the surface(s) of the light guide. These bumps or grooves redirect light without scattering. Furthermore, the dots 403 may be holographic optical elements (HOEs) fabricated or affixed by known techniques. The HOE's, like the dots described thus far will diffusively reflect light incident thereon. Moreover, it is noted that the dots 403 may be made from the material of layer 107. To this end, this material may be a film, and the desired shaped dots 403 may be formed from this film. As referenced previously, the layer 107 substantially diffusively reflects incident light. As such, the material used for layer 107 is an excellent choice from which to make the dots 403. The dots 403 formed from the material of layer 107 could be laminated to the bottom surface 108 of the light guide 105 in a manner similar to that used to laminate the layer 107 to other selected sides (e.g., side 110) of the light guide.

In addition to improving the transmission of light from the light source out of the light guide 105, the dots 403 and layers 107 are useful in recycling light that is reflected back from the elements of the backlight assembly. For example, light 406, which may be polarized, is reflected back from one of the elements of the backlight assembly (e.g., the brightness enhancement layer 103, the reflective polarizer 102, or the light valve 101) and is transmitted through the surface 111 to one of the dots 403, where it is diffusively reflected as light 407. Light 407 may then be reflected from the layer 107 disposed over surface 110, or may be transmitted through the surface 111. It is emphasized that light 407 is but one of the rays of the light 406 that is reflected. To wit, the diffusely reflecting dots 403 will provide light over a wide angle, such as described in connection with the reflection of light per Lambert's cosine law discussed in connection with FIG. 3. Whether the light 406 as reflected is truly Lambertian or substantially diffusively reflected, a portion of the light would otherwise be lost if not for the layer 107 disposed over the surface 108. However, some of light 406 may be diffusively reflected as light 408 by the dot 403 and traverse the air gap 120. The light 408 is then diffusively reflected by the layer 107 as light 409. Clearly, similar reflections from the dots 403 enhance the transmission of light from the light source to the backlight assembly and the recycling of light that is reflected back from the components of the backlight assembly. Ultimately, the arrangement of the example embodiments provides improved illumination and improved uniformity (i.e., fewer, or less severe light and dark regions at the imaging surface, or both.) at the imaging surface.

For light (not shown) propagating in the plane (or near the plane) which is perpendicular to plane of the paper of FIG. 4, it gets trapped in the light guide 105 if the reflective layer 107 over the surface 110 is specularly reflective. However, because the reflective layer 107 is diffusely reflective, the light that otherwise would be lost will be scattered out of the surface 111.

As will be appreciated from the quantitative description that follows, the efficiency an uniformity of the light transmitted from the light source to the light valve and thus the image surface is improved compared to known devices due to the improvement in recycling of light reflected back through surface 111 and in transmission of light from the light source 106 through the surface 111. Both of these improvements are a result of the selective incorporation of layers 107, dots 403 and the illustrative materials of which the layers 107 and dots 403 are comprised.

FIG. 5 is a tabular representation of the simulated performance of an illustrative light source and light guide when used in combination with a pair of crossed brightness enhancement layers 103, a polarization selective reflector 102, and an absorptive polarizer 122. The source was a CCFL that provides 19.25 Lumens, and the reflective layers on the surfaces of the light guide and light source are designated in the table by reflectance (%) and reflection type, Lambertian (L) or specular (S). To wit, the table includes the reflector around the CCFL 106, the reflective film underneath (e.g., disposed over surface 108) of the light guide 105 the dots 403, and the sides of the light guide that may also have a layer thereover (e.g., surfaces 110, 201 and 202). It is emphasized that there is an air gap between the bottom surface 108 and the reflective film 107.

The data of FIG. 5 provide comparative examples. In each example, the total flux data refer to total flux received at a plane 125 between the polarizer 122 and the light valve 101 of the same size as the light guide immediately above the polarizer 122. The total flux describes the total light efficiency. The numbers in the right-most column refer to total flux received at the plane 125 only in a 5 degree cone that faces the plane 125. The total flux in a 5 degree cone relates to on-axis luminance.

In the first set of Examples, No. 1-No. 8, the CCFL reflector has a reflectivity of 90%. The reflective layers underneath and around the sides of the light guide and dots, have a reflectivity of 90% as well. The best example is found to be Example No. 1, where the CCFL is specularly reflective, while the reflective layer, dots, and sides are lambertian reflective, which results in a maximum total flux (2.34318 lumens) over the entire light guide area and a maximum total flux (0.05482 lumens) in a 5 degree cone, compared to other examples. The least desirable example is Example No. 7 where all surfaces are specularly reflective. Due to light trapping in the light guide, very little light comes out (0.09122 lumens in total flux, and 0.00124 lumens in total flux in a 5 degree cone).

Example No. 2 is the same as Example No. 1, except in No. 2 the CCFL reflector is a substantially Lamertian reflector. Example No. 3 is the same as Example No. 1 except that the reflective layer over the sides of the light guide are specular reflectors. Example No. 4 is the same as Example no. 1 except in Example No. 4 the reflective layer underneath is a specular reflector. Example No. 5 is the same as Example No. 1 except in Example No. 5 the dots are specularly reflective. Example No. 6 is the same as Example No. 1 except in Example No. 6 the dots and the reflective layer underneath are specularly reflective. Example No. 8 is the same as Example No. 1 except in Example No. 6 the reflective layers underneath and over the sides are specularly reflective.

In the second set of Examples No. 9-No. 11, the CCFL reflector has an ideal reflectivity of 100%. The reflective layers underneath and around the sides of the light guide and dots, have a reflectivity of 98% as well. Again, the best example is the one with specular reflector around the CCFL, Lambertian reflector for reflective layers underneath and over the sides of the light guide, and Lambertian reflector for the dots, as represented by Example No. 11 with a maximum total flux (4.16310 lumens) over the entire light guide area and a maximum total flux (0.09525 lumens) in a 5 degree cone, compared to examples No. 9 and No. 10. Example No. 9 is the same as Example No. 11 except that the reflective layer over the sides of the light guide are specular reflectors. Example No. 10 is the same as Example No. 11 except that the reflective layer underneath and over the sides are specularly reflective.

The comparison between Example No. 1 and No. 11 further indicates that the higher the diffusive reflectivity, the higher total flux is.

It should be noted that the numbers in the total flux are impacted by a number of factors including but not limited to followings: the shape and reflectance of the reflector 114 around the light source, the emitted flux from the light source 106, the shape, size, and material of the light guide 105, the size, shape, spacing, and reflectance of the dots, the reflectance of the reflective layers 107, the reflectance and transmittance of the polarization selective layer, the shape and material of the brightness enhancement layers. All of the above factors except those mentioned explicitly are kept unchanged in Example No. 1 through No. 11. As can be readily appreciated from a review of FIG. 5, the relative total flux at the top surface of the light guide is greatest when all surfaces are diffusively reflective, excepting the reflector at the light source. Moreover, this table shows that use of specular reflection at all surfaces provides the worst illuminance.

As can be readily appreciated from a review of the example embodiments, use of the diffuse reflector layer 107 over a plurality of surfaces of the light guide provides an increase in optical efficiency, relative to the use of a diffuse reflector only on the bottom surface of the light guide. Overall, the use of the diffuse reflectors of the example embodiments beneath and on selected side surfaces of the light guide illustratively provides at least approximately 20% greater total flux (i.e., at least approximately 20% greater optical efficiency) than the exclusive use of specular reflectors.

In accordance with illustrative embodiments, diffuse reflectors used in the backlight assembly of a typical liquid crystal display, provide an improved optical efficiency (illuminance) compared to known structures that include specular reflectors over certain surfaces of the light guide. Further, the various methods, materials, components and parameters are included by way of example only and not in any limiting sense. Therefore, the embodiments described are illustrative and are useful in providing beneficial backlight assemblies. In view of this disclosure, those skilled in the art can implement the various example devices and methods to effect improved backlight efficiency, while remaining within the scope of the appended claims.

1. A display apparatus, comprising:
a light guide having at least two surfaces over which a substantially diffusively reflective layer is disposed, wherein the diffusively reflective layer has a reflectivity of at least 94%, and a diffusivity of at least 97%.

2. A display apparatus as recited in claim 1, wherein the light guide has at least one surface that is substantially transmissive of light.

3. A display apparatus as recited in claim 1, further comprising a plurality of discrete diffusive reflectors disposed on at least one of the two surfaces, over which the diffusive reflective layer is disposed.

4. A display apparatus as recited in claim 1, wherein the layer has an index of refraction that is substantially the same as or greater than an index of refraction of the light guide.

5. A display apparatus as recited in claim 1, wherein the layer has an index of refraction that is less than an index of refraction of the light guide.

6. A display apparatus as recited in claim 1, wherein the light guide is a rectangular parallel-piped.

7. A display apparatus as recited in claim 1, wherein the light-guide is a regular polyhedron.

8. A display apparatus as recited in claim 6, wherein the light-guide is a regular polyhedron.

9. A display apparatus as recited in claim 2, wherein at least one surface that is substantially transmissive of light is an exit surface of the light to other elements of the display apparatus.

10. A display apparatus as recited in claim 9, wherein the other elements include a light-valve and a reflective polarizer, wherein the reflective polarizer reflects light of a first polarization state and transmits light of a second polarization state.

11. A display apparatus as recited in claim 10, wherein the light valve is a liquid crystal (LC) panel.

12. A display apparatus as recited in claim 1, wherein an increase of at least 20% in optical efficiency is realized.

13. A display apparatus as recited in claim 6, wherein four sides of the regular parallel-piped have the diffusively reflective layer disposed thereover, one side is a light transmitting side and another side is operatively coupled to a light source.

14. A display apparatus as recited in claim 13, wherein three sides of the regular parallel-piped have the diffusively reflective layer disposed thereover, one side is a light transmitting side and two sides are operatively coupled to respective light sources.

15. A display apparatus as recited in claim 1, wherein one of the two surfaces is a bottom surface that is opposite a transmission surface of the light guide and an air gap is disposed between the layer and portions of the bottom surface.

16. A display apparatus as recited in claim 15, wherein a plurality of reflective dots is disposed over the bottom surface, and each of the dots are substantially in contact with the layer.

17. A display apparatus as recited in claim 16, wherein the reflective dots are of a material that is the same as a material of the layer.

18. A display apparatus as recited in claim 13, wherein one of the two surfaces is a bottom surface that is opposite to a transmission surface of the light guide and an air gap is disposed between the layer and portions of the bottom surface.

19. A display apparatus as recited in claim 18, wherein a plurality of reflective dots is disposed over the bottom surface, and each of the dots are substantially in contact with the layer.

20. A display apparatus as recited in claim 19, wherein the reflective dots are of a material that is the same as a material of the layer.

21. A method of transmitting light to a display, the method comprising:
providing a light guide; and
diffusively reflecting light from at least two surfaces of the light-guide.

22. A method as recited in claim 21, wherein the light guide has at least one surface that is substantially transmissive of light.

23. A method as recited in claim 21, further comprising a plurality of discrete diffusive reflectors disposed on at least one of the two surfaces, over which the diffusive reflective layer is disposed.

24. A method as recited in claim 21, wherein the layer has an index of refraction that is substantially the same as or greater than an index of refraction of the light guide.

25. A method as recited in claim 21, wherein the layer has an index of refraction that is less than an index of refraction of the light guide.

26. A method as recited in claim 21, wherein the light guide is a rectangular parallel-piped.

27. A method as recited in claim 21, wherein the light-guide is a regular polyhedron.

28. A method as recited in claim 21, wherein the light-guide is a polyhedron.

29. A method as recited in claim 22, wherein at least one surface that is substantially transmissive of light is an exit surface of the light to other elements of the display apparatus.

30. A method as recited in claim 29, wherein the other elements include a light-valve, and a reflective polarizer which reflects light of a first polarization state and transmits light of a second polarization state.

31. A method as recited in claim 30, wherein the light valve is a liquid crystal (LC) panel.

32. A method as recited in claim 30, wherein the light of the first polarization state is converted to the second polarization state and at least partially recycled back the light valve by at least two surfaces over which the diffusive reflecting layer is disposed.

34. A method as recited in claim 21, wherein an increase of at least 20% in optical efficiency is realized

35. A method as recited in claim 26, wherein four sides of the regular parallel-piped have the diffusively reflective layer disposed thereover, one side is a light transmitting side and another side is operatively coupled to a light source.

36. A method as recited in claim 26, wherein three sides of the regular parallel-piped have the diffusively reflective layer disposed thereover, one side is a light transmitting side and two sides are operatively coupled to respective light sources.

37. A method as recited in claim 21, wherein one of the two surfaces is a bottom surface that is opposite a transmission surface of the light guide and an air gap is disposed between the layer and portions of the bottom surface.

38. A method as recited in claim 37, wherein a plurality of reflective dots is disposed over the bottom surface, and each of the dots are substantially in contact with the layer.

39. A method as recited in claim 38, wherein the reflective dots of a material that is the same as a material of the layer.

40. A method as recited in claim 35, wherein one of the two surfaces is a bottom surface that is opposite a transmission surface of the light guide and an air gap is disposed between the layer and portions of the bottom surface.

41. A method as recited in claim 40, wherein a plurality of reflective dots is disposed over the bottom surface, and each of the dots are substantially in contact with the layer.

42. A method as recited in claim 41, wherein the reflective dots are of a material that is the same as a material of the layer.
